(19) United States
(12) Patent Application Publication
(10) Pub. No.: US 2024/0062303 A1
(43) Pub. Date: Feb. 22, 2024

(54) METHOD AND SYSTEM FOR DETECTING UMBRELLA SUB-FUND RELATIONSHIPS

(71) Applicant: JPMorgan Chase Bank, N.A., New York, NY (US)

(72) Inventors: Simran LAMBA, Manhattan, NY (US); Xiaomo LIU, Manhasset, NY (US)

(73) Assignee: JPMorgan Chase Bank, N.A., New York, NY (US)

(21) Appl. No.: 17/888,994

(22) Filed: Aug. 16, 2022

(51) Int. Cl. G06Q 40/06; G06N 20/00

(52) U.S. Cl. CPC G06Q 40/06; G06N 20/00

(57) ABSTRACT

Methods and systems for automatically identifying umbrella sub-funds from within an umbrella investment fund are provided. The method includes: receiving a first data set that includes entity-specific records; retrieving, for each respective entity-specific record, a corresponding set of entity-specific reference data; extracting, from each respective set of reference data, a corresponding umbrella name; determining, based on the corresponding umbrella name, whether the respective entity is associated with a particular sub-fund; and associating the respective entity with other entities that have previously been determined as being associated with the particular sub-fund. The determination may be made by applying an artificial intelligence (AI) algorithm that uses a machine learning technique to determine a probability with respect to whether the respective entity is associated with the particular sub-fund.

### BACKGROUND

### 1. Field of the Disclosure

This technology generally relates to methods and systems for identifying relationships within umbrella fund investment groups, and more particularly to methods and systems for automatically identifying umbrella sub-funds which are effectively traded as individual investment funds within umbrella funds and thereby streamlining know-your-customer (KYC) procedures while increasing efficiency and reducing human error.

### 2. Background Information

An umbrella fund is a collective investment scheme that exists as a single legal entity but typically includes several distinct sub-funds, each of which is effectively traded as an individual investment fund.

For a large financial institution that handles umbrella funds, there is a need to identify sub-fund relationships within each umbrella fund, in order to streamline know-your-customer (KYC) procedures that are required for compliance with governmental regulations by allowing for the KYC procedures to be performed on the umbrella fund as a whole instead of on each sub-fund. This sub-fund identification task is typically performed manually by a human. However, in many instances, the task entails reviewing large volumes of information, and therefore may be quite time-consuming and prone to errors.

Accordingly, there is a need for a mechanism for automatically identifying umbrella sub-funds which are effectively traded as individual investment funds within umbrella funds and thereby streamlining KYC procedures while increasing efficiency and reducing human error.

### SUMMARY

The present disclosure, through one or more of its various aspects, embodiments, and/or specific features or sub-components, provides, inter alia, various systems, servers, devices, methods, media, programs, and platforms for methods and systems for automatically identifying umbrella sub-funds which are effectively traded as individual investment funds within umbrella funds and thereby streamlining know-your-customer (KYC) procedures while increasing efficiency and reducing human error.

According to an aspect of the present disclosure, a method for automatically identifying umbrella sub-funds from within an umbrella investment fund is provided. The method is implemented by at least one processor. The method includes: receiving, by the at least one processor, a first data set that includes a plurality of entity-specific records, each respective entity-specific record relating to a respective entity; retrieving, by the at least one processor for each respective entity-specific record in the first data set, a corresponding set of entity-specific reference data; extracting, from each respective set of reference data, a corresponding umbrella name; determining, by the at least one processor based on the corresponding umbrella name, whether the respective entity is associated with a particular sub-fund; and associating, by the at least one processor, the respective entity with at least one other entity that has previously been determined as being associated with the particular sub-fund.

At least one from among the plurality of entity-specific records may include a Legal Entity Identifier (LEI) that corresponds to the respective entity.

The retrieving may include searching in a Global Legal Entity Identifier Foundation (GLIEF) database for information that matches with the respective entity-specific record.

The determining of whether the respective entity is associated with a particular sub-fund may include applying an artificial intelligence (AI) algorithm that uses a machine learning technique to determine a probability with respect to whether the respective entity is associated with the particular sub-fund.

The AI algorithm may be trained by using historical information that relates to known umbrella sub-funds.

When the corresponding umbrella name includes at least one hyphen, the AI algorithm may use a length of the corresponding umbrella name, a respective hyphen position of each of the at least one hyphen within the corresponding umbrella name, a spacing of each of the at least one hyphen within the corresponding umbrella name, and an umbrella token number as inputs for determining a syntax feature probability that is usable for determining the probability with respect to whether the respective entity is associated with the particular sub-fund.

The AI algorithm may use an umbrella trailing token and a sub trailing token as inputs for determining a semantic feature probability that is usable in conjunction with the syntax feature probability for determining the probability with respect to whether the respective entity is associated with the particular sub-fund.

When the corresponding umbrella name does not include a hyphen, the respective entity may be determined as not being associated with the particular sub-fund.

When a respective entity is determined as not being associated with a particular sub-fund, the method may further include extracting entity-specific prospectus information from the corresponding set of reference data and using the entity-specific prospectus information to confirm that the respective entity is not associated with the particular sub-fund.

According to another exemplary embodiment, a computing apparatus for automatically identifying umbrella sub-funds from within an umbrella investment fund is provided. The computing apparatus includes a processor; a memory; and a communication interface coupled to each of the processor and the memory. The processor is configured to: receive, via the communication interface, a first data set that includes a plurality of entity-specific records, each respective entity-specific record relating to a respective entity; retrieve, for each respective entity-specific record in the first data set, a corresponding set of entity-specific reference data; extract, from each respective set of reference data, a corresponding umbrella name; determine, based on the corresponding umbrella name, whether the respective entity is associated with a particular sub-fund; and associate the respective entity with at least one other entity that has previously been determined as being associated with the particular sub-fund.

At least one from among the plurality of entity-specific records may include a Legal Entity Identifier (LEI) that corresponds to the respective entity.

The processor may be further configured to search in a Global Legal Entity Identifier Foundation (GLIEF) database for information that matches with the respective entity-specific record.

The processor may be further configured to apply an artificial intelligence (AI) algorithm that uses a machine learning technique to determine a probability with respect to whether the respective entity is associated with the particular sub-fund.

The AI algorithm may be trained by using historical information that relates to known umbrella sub-funds.

When the corresponding umbrella name includes at least one hyphen, the AI algorithm may use a length of the corresponding umbrella name, a respective hyphen position of each of the at least one hyphen within the corresponding umbrella name, a spacing of each of the at least one hyphen within the corresponding umbrella name, and an umbrella token number as inputs for determining a syntax feature probability that is usable for determining the probability with respect to whether the respective entity is associated with the particular sub-fund.

The AI algorithm may use an umbrella trailing token and a sub trailing token as inputs for determining a semantic feature probability that is usable in conjunction with the syntax feature probability for determining the probability with respect to whether the respective entity is associated with the particular sub-fund.

When the corresponding umbrella name does not include a hyphen, the processor may be further configured to determine that the respective entity is not associated with the particular sub-fund.

When a respective entity is determined as not being associated with a particular sub-fund, the processor may be further configured to extract entity-specific prospectus information from the corresponding set of reference data and use the entity-specific prospectus information to confirm that the respective entity is not associated with the particular sub-fund.

According to yet another exemplary embodiment, a non-transitory computer readable storage medium storing instructions for automatically identifying umbrella sub-funds from within an umbrella investment fund is provided. The storage medium includes executable code which, when executed by a processor, causes the processor to: receive a first data set that includes a plurality of entity-specific records, each respective entity-specific record relating to a respective entity; retrieve, for each respective entity-specific record in the first data set, a corresponding set of entity-specific reference data; extract, from each respective set of reference data, a corresponding umbrella name; determine, based on the corresponding umbrella name, whether the respective entity is associated with a particular sub-fund; and associate the respective entity with at least one other entity that has previously been determined as being associated with the particular sub-fund.

At least one from among the plurality of entity-specific records may include a Legal Entity Identifier (LEI) that corresponds to the respective entity.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automatically identifying umbrella sub-funds which are effectively traded as individual investment funds within umbrella funds and thereby streamlining KYC procedures while increasing efficiency and reducing human error.

FIG. 4 is a flowchart of an exemplary process for implementing a method for automatically identifying umbrella sub-funds which are effectively traded as individual investment funds within umbrella funds and thereby streamlining KYC procedures while increasing efficiency and reducing human error.

FIG. 5 is a flow diagram that illustrates an artificial intelligence (AI) algorithm workflow by which an umbrella sub-fund detection determination is made in a method for automatically identifying umbrella sub-funds which are effectively traded as individual investment funds within umbrella funds and thereby streamlining KYC procedures while increasing efficiency and reducing human error, according to an exemplary embodiment.

FIG. 6 is an example of inputs and outputs of an AI algorithm that is used in connection with a method for automatically identifying umbrella sub-funds which are effectively traded as individual investment funds within umbrella funds and thereby streamlining KYC procedures while increasing efficiency and reducing human error, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

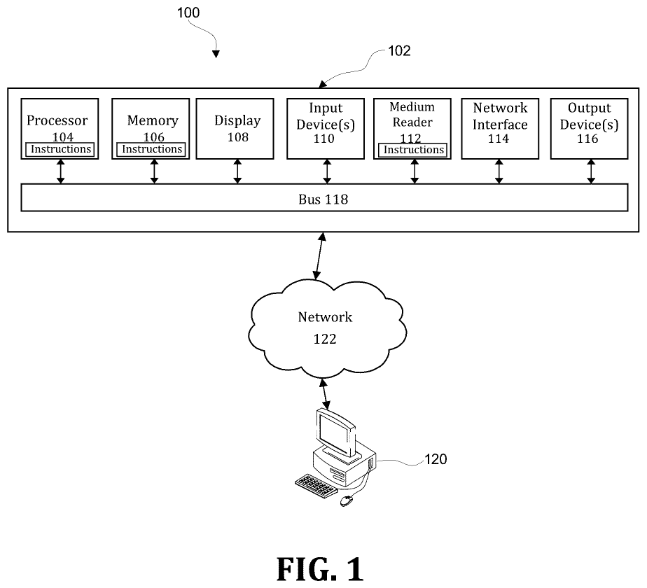

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically identifying umbrella sub-funds which are effectively traded as individual investment funds within umbrella funds and thereby streamlining know-your-customer (KYC) procedures while increasing efficiency and reducing human error.

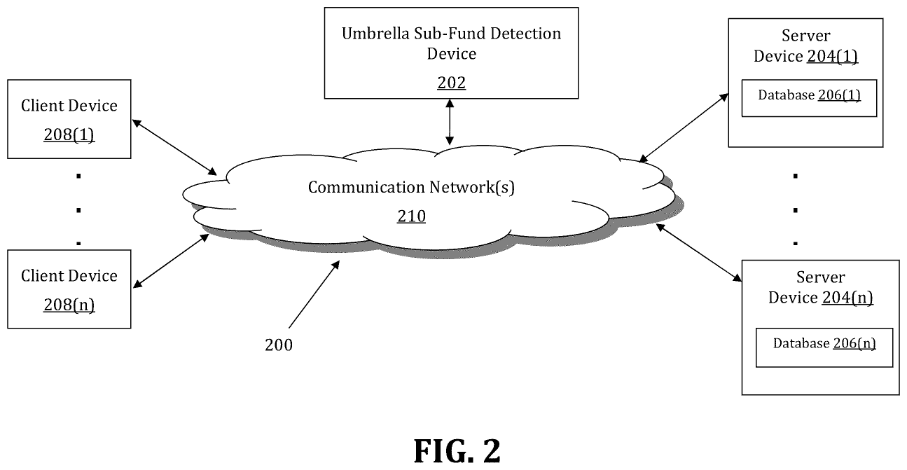

Referring to FIG. 2, a schematic of an exemplary network environment 200 for implementing a method for automatically identifying umbrella sub-funds which are effectively traded as individual investment funds within umbrella funds and thereby streamlining KYC procedures while increasing efficiency and reducing human error is illustrated. In an exemplary embodiment, the method is executable on any networked computer platform, such as, for example, a personal computer (PC).

The method for automatically identifying umbrella sub-funds which are effectively traded as individual investment funds within umbrella funds and thereby streamlining KYC procedures while increasing efficiency and reducing human error may be implemented by an Umbrella Sub-Fund Detection (USFD) device 202. The USFD device 202 may be the same or similar to the computer system 102 as described with respect to FIG. 1. The USFD device 202 may store one or more applications that can include executable instructions that, when executed by the USFD device 202, cause the USFD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the USFD device 202 itself, may be located in virtual server(s) running in a cloud-based computing environment rather than being tied to one or more specific physical network computing devices. Also, the application(s) may be running in one or more virtual machines (VMs) executing on the USFD device 202. Additionally, in one or more embodiments of this technology, virtual machine(s) running on the USFD device 202 may be managed or supervised by a hypervisor.

In the network environment 200 of FIG. 2, the USFD device 202 is coupled to a plurality of server devices 204(1)-204(n) that hosts a plurality of databases 206(1)-206(n), and also to a plurality of client devices 208(1)-208(n) via communication network(s) 210. A communication interface of the USFD device 202, such as the network interface 114 of the computer system 102 of FIG. 1, operatively couples and communicates between the USFD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the USFD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and USFD devices that efficiently implement a method for automatically identifying umbrella sub-funds which are effectively traded as individual investment funds within umbrella funds and thereby streamlining KYC procedures while increasing efficiency and reducing human error.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The USFD device 202 may be a standalone device or integrated with one or more other devices or apparatuses, such as one or more of the server devices 204(1)-204(n), for example. In one particular example, the USFD device 202 may include or be hosted by one of the server devices 204(1)-204(n), and other arrangements are also possible. Moreover, one or more of the devices of the USFD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the USFD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical data that relates to umbrella funds and information that relates to individual entities that participate in umbrella funds.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the USFD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the USFD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the USFD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the USFD device 202, the server devices 204(1)-204(n), or the client devices 208(1)-208(n), for example, may be configured to operate as virtual instances on the same physical machine. In other words, one or more of the USFD device 202, the server devices 204(1)-204(n), or the client devices 208(1)-208(n) may operate on the same physical device rather than as separate devices communicating through communication network(s) 210. Additionally, there may be more or fewer USFD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

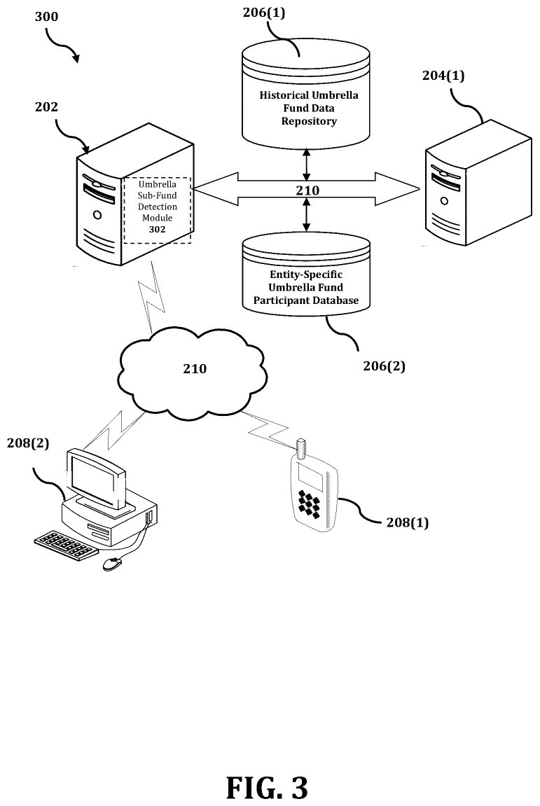

The USFD device 202 is described and illustrated in FIG. 3 as including an umbrella sub-fund detection module 302, although it may include other rules, policies, modules, databases, or applications, for example. As will be described below, the umbrella sub-fund detection module 302 is configured to implement a method for automatically identifying umbrella sub-funds which are effectively traded as individual investment funds within umbrella funds and thereby streamlining KYC procedures while increasing efficiency and reducing human error.

An exemplary process 300 for implementing a mechanism for automatically identifying umbrella sub-funds which are effectively traded as individual investment funds within umbrella funds and thereby streamlining KYC procedures while increasing efficiency and reducing human error by utilizing the network environment of FIG. 2 is illustrated as being executed in FIG. 3. Specifically, a first client device 208(1) and a second client device 208(2) are illustrated as being in communication with USFD device 202. In this regard, the first client device 208(1) and the second client device 208(2) may be “clients” of the USFD device 202 and are described herein as such. Nevertheless, it is to be known and understood that the first client device 208(1) and/or the second client device 208(2) need not necessarily be “clients” of the USFD device 202, or any entity described in association therewith herein. Any additional or alternative relationship may exist between either or both of the first client device 208(1) and the second client device 208(2) and the USFD device 202, or no relationship may exist.

Further, USFD device 202 is illustrated as being able to access a historical umbrella fund data repository 206(1) and an entity-specific umbrella fund participant database 206(2). The umbrella sub-fund detection module 302 may be configured to access these databases for implementing a method for automatically identifying umbrella sub-funds which are effectively traded as individual investment funds within umbrella funds and thereby streamlining KYC procedures while increasing efficiency and reducing human error.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the USFD device 202 via broadband or cellular communication. Of course, these embodiments are merely exemplary and are not limiting or exhaustive.

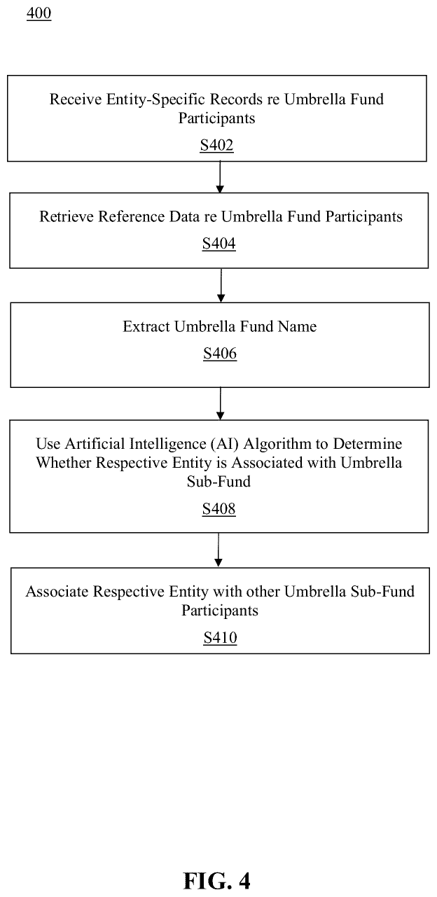

Upon being started, the umbrella sub-fund detection module 302 executes a process for automatically identifying umbrella sub-funds which are effectively traded as individual investment funds within umbrella funds and thereby streamlining KYC procedures while increasing efficiency and reducing human error. An exemplary process for automatically identifying umbrella sub-funds which are effectively traded as individual investment funds within umbrella funds and thereby streamlining KYC procedures while increasing efficiency and reducing human error is generally indicated at flowchart 400 in FIG. 4.

In process 400 of FIG. 4, at step S402, the umbrella sub-fund detection module 302 receives a data set that includes entity-specific records for entities that participate in various umbrella funds. In an exemplary embodiment, the number of entity-specific records may be quite large, such as, for example, hundreds of records, thousands of records, tens of thousands of records, hundreds of thousands of records, millions of records, or any other large number of records. In an exemplary embodiment, at least some of the records may include Legal Entity Identifiers (LEIs) that correspond to the respective entities.

At step S404, for each respective entity-specific record received in step S402, the umbrella sub-fund detection module 302 retrieves corresponding entity-specific reference data. In an exemplary embodiment, the retrieval operation may be performed by searching in a Global Legal Entity Identifier Foundation (GLEIF) database for information that matches with the respective entity-specific record. In an exemplary embodiment, the reference data may include prospectus information that relates to the corresponding entity.

At step S406, the umbrella sub-fund detection module 302 extracts an umbrella fund name from the entity-specific reference data retrieved in step S404. Then, at step S408, the umbrella sub-fund detection module 302 uses the extracted umbrella fund name to make a determination as to whether the respective entity is associated with a particular umbrella sub-fund.

In an exemplary embodiment, a determination as to whether a respective entity is associated with a particular umbrella sub-fund is made by applying an artificial intelligence (AI) algorithm that uses a machine learning technique to determine a probability with respect to whether the respective entity is associated with the particular umbrella sub-fund. In an exemplary embodiment, the AI algorithm is trained by using historical data that relates to known umbrella sub-funds.

The AI algorithm may operate by analyzing the umbrella fund name extracted in step S406 in order to make various assessments that provide guidance as to whether the respective entity is associated with a particular sub-fund. For example, when the umbrella fund name includes at least one hyphen, the AI algorithm may use a length of the umbrella name, a respective hyphen position of each hyphen within the umbrella name, a respective spacing of each hyphen, and an umbrella token number as inputs. In an exemplary embodiment, the AI algorithm then generates a syntax feature probability that is usable for determining an overall probability that the respective entity is associated with a particular umbrella sub-fund. In addition, the AI algorithm may also use an umbrella trailing token and a sub trailing token as inputs for generating a semantic feature probability that is also usable for determining the overall probability that the respective entity is associated with the particular umbrella sub-fund.

In an exemplary embodiment, when the umbrella fund name extracted in step S406 does not include at least one hyphen, the AI algorithm determines that the respective entity is not associated with any particular umbrella sub-fund. In an exemplary embodiment, when a respective entity is determined as not being associated with a particular sub-fund, prospectus information that is included in the reference data retrieved in step S404 may be extracted and used to confirm the determination that the respective entity is not associated with any particular sub-fund.

At step S410, the umbrella sub-fund detection module associates each respective entity that has been determined as being associated with a particular sub-fund with other entities that had previously been determined as being associated with the same sub-fund. In this manner, once all of the records received in step S402 have been processed, a complete set of umbrella sub-fund affiliations may be realized.

In an exemplary embodiment, a method for automatically identifying umbrella sub-funds which are effectively traded as individual investment funds within umbrella funds is intended to streamline know-your-customer (KYC) procedures while increasing efficiency and reducing human error. One approach to achieving this objective is to leverage artificial intelligence (AI) techniques. For example, AI is useful for recognizing images and videos, i.e., photo tagging; comprehending languages in text, i.e., machine translation; understanding audio speech; identifying patterns and making decisions based on historical information associated with such patterns; and generally acting like a human in many aspects. Various use cases for which AI has been applied include the following: automating financial analysis based on annual reports; utilizing image recognition for extracting tabular data from pdf files; and creating application programming interfaces (APIs) and machines to execute image recognition algorithms.

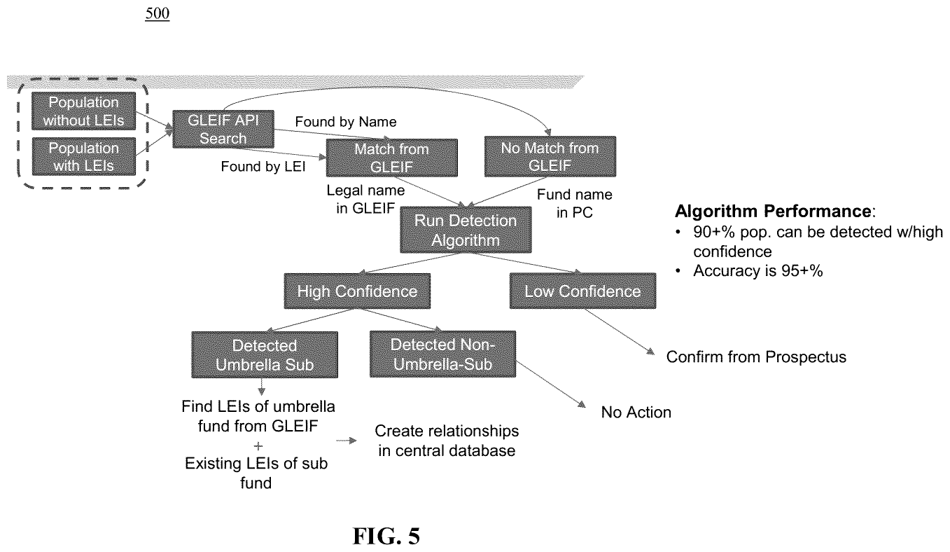

FIG. 5 is a flow diagram 500 that illustrates an artificial intelligence (AI) algorithm workflow by which an umbrella sub-fund detection determination is made in a method for automatically identifying umbrella sub-funds which are effectively traded as individual investment funds within umbrella funds and thereby streamlining KYC procedures while increasing efficiency and reducing human error, according to an exemplary embodiment.

Referring to flow diagram 500, the AI workflow begins with a set of entity-specific records, some of which include Legal Entity Identifiers (LEIS) for the respective entities, and some of which do not include LEIS. The records are used for performing a search of the Global Legal Entity Identifier Foundation (GLEIF) database in order to retrieve reference information for each respective entity.

The output of the GLIEF database search includes some matching information that is found based on the corresponding LEI, some other matching information that is found based on a name of the corresponding entity, and some other records for which no match is found in the GLEIF database. In the case of records for which matching information is found in the GLEIF database, the matching information is then fed into the AI algorithm as an input. In the case of records for which no matching information is found in the GLEIF database, the reference information may still include an umbrella fund name that is usable as an input into the AI algorithm. The AI algorithm is then executed with respect to the inputted information.

Upon execution, the AI algorithm generates an output indicating whether or not a particular umbrella sub-fund association has been detected for each inputted record, and the output includes an indication as to a confidence level as to whether the determination of the umbrella sub-fund detection is accurate. In an exemplary embodiment, in an experiment, the AI algorithm was able to make detections with high confidence levels on more than ninety percent (90%) of the inputted records, and the accuracy of those detections was greater than ninety-five percent (95%).

In an exemplary embodiment, with respect to records for which a low confidence level is found, the AI algorithm uses prospectus information that relates to the corresponding entities to confirm that there is no basis for affirmatively determining an association with any particular umbrella sub-fund. With respect to records for which a high confidence level is found, the AI algorithm may affirmatively determine that no sub-fund association exists for certain entities, and for those entities, no further action is taken. When the AI algorithm affirmatively determines that a particular umbrella sub-fund association has been detected for a given entity, then LEIS of the umbrella fund and the particular sub-fund are associated with the given entity and relationships therebetween are created and stored in a central information repository.

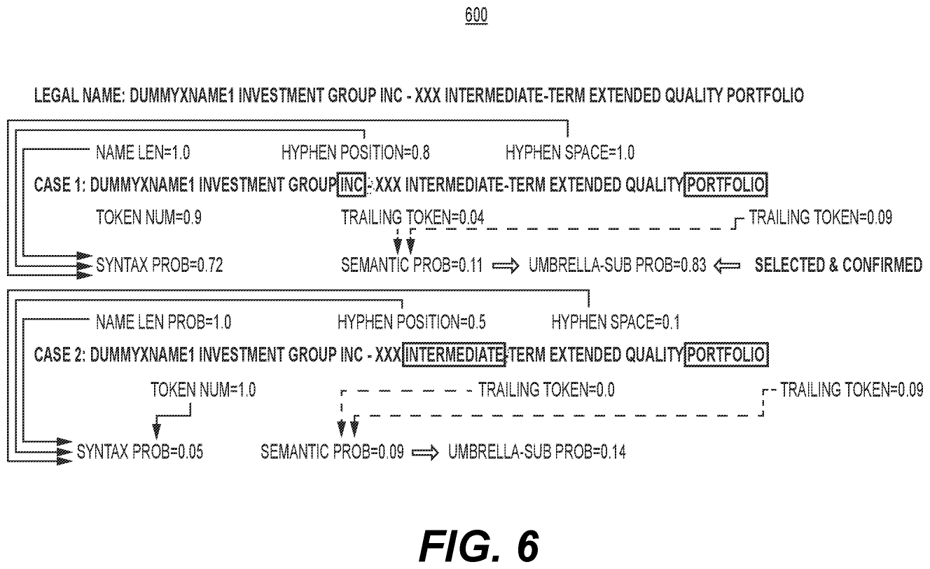

FIG. 6 is an example 600 of inputs and outputs of an AI algorithm that is used in connection with a method for automatically identifying umbrella sub-funds which are effectively traded as individual investment funds within umbrella funds and thereby streamlining KYC procedures while increasing efficiency and reducing human error, according to an exemplary embodiment.

As shown in FIG. 6, a legal name of an umbrella fund may be extracted from the reference data retrieved with respect to a particular entity, such as, for example, “DUMMYXNAME 1 INVESTMENT GROUP INC—XXX Intermediate-Term Extended Quality Portfolio”. This legal name may be analyzed by the AI algorithm with respect to 1) a name length; 2) a hyphen position within the name; 3) a hyphen spacing; 4) an umbrella token number; 5) an umbrella trailing token; and 6) a sub trailing token.

In the example 600, there are two hyphens, and so the AI algorithm operates on the same legal name twice, once for the first hyphen and once for the second hyphen. In the first instance (labeled as “Case 1”), the name length is assigned a value of 1.0; the hyphen position is assigned a value of 0.8; the hyphen spacing is assigned a value of 1.0; and the umbrella token number is assigned a value of 0.9. These values are then combined to generate a syntax probability value of 0.72. In addition, the AI algorithm assigns a value of 0.04 to the umbrella trailing token (i.e., “INC”) and a value of 0.09 to the sub trailing token (i.e., “Portfolio”), and these values are also combined to generate a semantic probability value of 0.11. Finally, the AI algorithm adds the syntax probability and the semantic probability together to obtain an overall umbrella sub-fund probability value of 0.83, which indicates an 83% probability that the legal name is indicative that the respective entity is associated with the particular sub-fund that is identified in the legal name. The AI algorithm determines that the 83% probability is sufficient to select and confirm Case 1 as being indicative of an affirmative determination of such a sub-fund association. Importantly, the AI algorithm recognizes that when the hyphen position is relatively early in the overall legal name and the hyphen spacing includes a blank space before the hyphen and a blank space after the hyphen, these syntactical features are usually indicative of an identification of a sub-fund within the legal name, and therefore, the AI algorithm assigns relatively high values for this features, thus leading to an overall positive determination of a sub-fund detection.

By contrast, in the second instance shown in FIG. 6 (labeled as “Case 2”), the name length is again assigned a value of 1.0 and the umbrella token number is assigned a value of 1.0, but the hyphen position is assigned a value of 0.5 and the hyphen spacing is assigned a value of 0.1. These values are then combined to generate a syntax probability value of 0.05. In addition, the AI algorithm assigns a value of 0.0 to the umbrella trailing token (i.e., “Intermediate”) and a value of 0.09 to the sub trailing token (i.e., “Portfolio”), and these values are also combined to generate a semantic probability value of 0.09. Finally, the AI algorithm adds the syntax probability and the semantic probability together to obtain an overall umbrella sub-fund probability value of 0.14, which indicates an 14% probability that the legal name is indicative that the respective entity is associated with the particular sub-fund that is identified in the legal name. The AI algorithm determines that the 14% probability is sufficient to make an affirmative determination that the second hyphen is not indicative of any particular sub-fund association. Importantly, the AI algorithm recognizes that when the hyphen position is relatively later in the overall legal name and the hyphen spacing does not include a blank space either before or after the hyphen, these syntactical features are usually indicative of a situation that does not relate to an identification of a sub-fund within the legal name, and therefore, the AI algorithm assigns relatively low values for this features, thus leading to an overall negative determination of a sub-fund detection.

Accordingly, with this technology, an optimized process for automatically identifying umbrella sub-funds which are effectively traded as individual investment funds within umbrella funds and thereby streamlining KYC procedures while increasing efficiency and reducing human error is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for automatically identifying umbrella sub-funds from within an umbrella investment fund, the method being implemented by at least one processor, the method comprising:
receiving, by the at least one processor, a first data set that includes a plurality of entity-specific records, each respective entity-specific record relating to a respective entity;
retrieving, by the at least one processor for each respective entity-specific record in the first data set, a corresponding set of entity-specific reference data;
extracting, from each respective set of reference data, a corresponding umbrella name;
determining, by the at least one processor based on the corresponding umbrella name, whether the respective entity is associated with a particular sub-fund; and
associating, by the at least one processor, the respective entity with at least one other entity that has previously been determined as being associated with the particular sub-fund.

2. The method of claim 1, wherein at least one from among the plurality of entity-specific records includes a Legal Entity Identifier (LEI) that corresponds to the respective entity.

3. The method of claim 1, wherein the retrieving comprises searching in a Global Legal Entity Identifier Foundation (GLIEF) database for information that matches with the respective entity-specific record.

4. The method of claim 1, wherein the determining of whether the respective entity is associated with a particular sub-fund comprises applying an artificial intelligence (AI) algorithm that uses a machine learning technique to determine a probability with respect to whether the respective entity is associated with the particular sub-fund.

5. The method of claim 4, wherein the AI algorithm is trained by using historical information that relates to known umbrella sub-funds.

6. The method of claim 4, wherein when the corresponding umbrella name includes at least one hyphen, the AI algorithm uses a length of the corresponding umbrella name, a respective hyphen position of each of the at least one hyphen within the corresponding umbrella name, a spacing of each of the at least one hyphen within the corresponding umbrella name, and an umbrella token number as inputs for determining a syntax feature probability that is usable for determining the probability with respect to whether the respective entity is associated with the particular sub-fund.

7. The method of claim 6, wherein the AI algorithm uses an umbrella trailing token and a sub trailing token as inputs for determining a semantic feature probability that is usable in conjunction with the syntax feature probability for determining the probability with respect to whether the respective entity is associated with the particular sub-fund.

8. The method of claim 1, wherein when the corresponding umbrella name does not include a hyphen, the respective entity is determined as not being associated with the particular sub-fund.

9. The method of claim 1, wherein when a respective entity is determined as not being associated with a particular sub-fund, the method further comprises extracting entity-specific prospectus information from the corresponding set of reference data and using the entity-specific prospectus information to confirm that the respective entity is not associated with the particular sub-fund.

10. A computing apparatus for automatically identifying umbrella sub-funds from within an umbrella investment fund, the computing apparatus comprising:
a processor;
a memory; and
a communication interface coupled to each of the processor and the memory, wherein the processor is configured to:
receive, via the communication interface, a first data set that includes a plurality of entity-specific records, each respective entity-specific record relating to a respective entity;
retrieve, for each respective entity-specific record in the first data set, a corresponding set of entity-specific reference data;
extract, from each respective set of reference data, a corresponding umbrella name;
determine, based on the corresponding umbrella name, whether the respective entity is associated with a particular sub-fund; and
associate the respective entity with at least one other entity that has previously been determined as being associated with the particular sub-fund.

11. The computing apparatus of claim 10, wherein at least one from among the plurality of entity-specific records includes a Legal Entity Identifier (LEI) that corresponds to the respective entity.

12. The computing apparatus of claim 10, wherein the processor is further configured to search in a Global Legal Entity Identifier Foundation (GLIEF) database for information that matches with the respective entity-specific record.

13. The computing apparatus of claim 10, wherein the processor is further configured to apply an artificial intelligence (AI) algorithm that uses a machine learning technique to determine a probability with respect to whether the respective entity is associated with the particular sub-fund.

14. The computing apparatus of claim 13, wherein the AI algorithm is trained by using historical information that relates to known umbrella sub-funds.

15. The computing apparatus of claim 13, wherein when the corresponding umbrella name includes at least one hyphen, the AI algorithm uses a length of the corresponding umbrella name, a respective hyphen position of each of the at least one hyphen within the corresponding umbrella name, a spacing of each of the at least one hyphen within the corresponding umbrella name, and an umbrella token number as inputs for determining a syntax feature probability that is usable for determining the probability with respect to whether the respective entity is associated with the particular sub-fund.

16. The computing apparatus of claim 15, wherein the AI algorithm uses an umbrella trailing token and a sub trailing token as inputs for determining a semantic feature probability that is usable in conjunction with the syntax feature probability for determining the probability with respect to whether the respective entity is associated with the particular sub-fund.

17. The computing apparatus of claim 10, wherein when the corresponding umbrella name does not include a hyphen, the processor is further configured to determine that the respective entity is not associated with the particular sub-fund.

18. The computing apparatus of claim 10, wherein when a respective entity is determined as not being associated with a particular sub-fund, the processor is further configured to extract entity-specific prospectus information from the corresponding set of reference data and use the entity-specific prospectus information to confirm that the respective entity is not associated with the particular sub-fund.

19. A non-transitory computer readable storage medium storing instructions for automatically identifying umbrella sub-funds from within an umbrella investment fund, the storage medium comprising executable code which, when executed by a processor, causes the processor to:
receive a first data set that includes a plurality of entity-specific records, each respective entity-specific record relating to a respective entity;
retrieve, for each respective entity-specific record in the first data set, a corresponding set of entity-specific reference data;
extract, from each respective set of reference data, a corresponding umbrella name;
determine, based on the corresponding umbrella name, whether the respective entity is associated with a particular sub-fund; and
associate the respective entity with at least one other entity that has previously been determined as being associated with the particular sub-fund.

20. The storage medium of claim 19, wherein at least one from among the plurality of entity-specific records includes a Legal Entity Identifier (LEI) that corresponds to the respective entity.
